(19) United States
(12) Patent Application Publication
(10) Pub. No.: US 2013/0218798 A1
(43) Pub. Date: Aug. 22, 2013

(54) SYSTEM AND METHOD FOR MANAGING FUNDRAISING

(71) Applicants: Jayaram Ponnada, Bloomington, IL (US); Douglas Fedewa, Bloomington, IL (US)

(72) Inventors: Jayaram Ponnada, Bloomington, IL (US); Douglas Fedewa, Bloomington, IL (US)

(21) Appl. No.: 13/769,242

(22) Filed: Feb. 15, 2013

Related U.S. Application Data
(60) Provisional application No. 61/599,900, filed on Feb. 16, 2012.

(51) Int. Cl. G06Q 40/00

(52) U.S. Cl. CPC G06Q 40/00
USPC 705/329

(57) ABSTRACT

A fundraising system includes: a controller adapted to: associate a unique identifier with each of a plurality of a fundraiser participants; receive an accounting from a financial institution identifying a plurality of deposits made to a single financial account at the financial institution, wherein each deposit is associated with one of the unique identifiers; and provide a user interface adapted to identify the one or more deposits contributed by each fundraiser participant using the associated unique identifier.

### CROSS-REFERENCE TO RELATED APPLICATIONS

This application incorporates by reference and claims priority to U.S. Provisional Patent Application No. 61/599,900 filed Feb. 16, 2012.

### BACKGROUND OF THE INVENTION

The present subject matter relates generally to systems and methods for managing fundraising. More specifically, the present invention relates to systems and methods for managing fundraising where the fundraising involves fundraisers who solicit donations from donors.

When fundraising, organizations often have fundraisers, such as members or supporters, personally solicit donations from likely donors. Donors are known to respond generously to the energy and enthusiasm fundraisers show in a personal appeal to donate. However, even the most trusting donor will worry about the possibility that the money they give to a fundraiser might be stolen. If donors could be given assurances about the security of their donation, donors may choose to be more generous. Likewise, fundraisers would have a desire to give those assurances, if they could, since that would increase donations to the cause they are passionate about. And from an organization's perspective, there is a need to ensure that all of the donations collected by the fundraisers are being received by the organization.

Even when the donations are safely conveyed to an organization, fundraising can create a burdensome need for the organization to collect, to consolidate, and to track the donations received by fundraisers. If the fundraising campaign involves a large number of individual participants and each individual participant receives physical donated funds such as coins, cash, and checks, the task of collecting the physical funds, consolidating the funds, and tracking the amount of donated funds collected by each individual participant may exceed organizational resources. Further, consolidating and tracking the donated funds is a labor-intensive, error-prone, and potentially costly process for the organization.

Accordingly, there is a need for systems and methods to manage fundraising that provide assurances to donors that their donations will be securely delivered to the organization and that reduce the cost and complexity of collecting, consolidating and tracking donations to an organization, as described herein.

### BRIEF SUMMARY OF THE INVENTION

To meet the needs described above and others, the present disclosure provides systems and methods to manage donations to an organization and to ensure the security of donations by providing an Internet-based platform for managing fundraising campaigns that tracks donations to an organization and by providing secure collection devices that fundraisers may use to collect donations and securely hold them until the donations are deposited at a financial institution on behalf of the organization.

In an embodiment, the present invention allows an organization to manage a fundraising campaign using an Internet-based fundraising platform. A fundraising campaign begins when an organization registers the fundraising campaign with the fundraising platform. An organization may then register fundraisers for a fundraising campaign with the fundraising platform, or permit the fundraisers to login and register themselves with the campaign. In addition, fundraisers or other interested parties can invite third parties to join a campaign. For example, a fundraiser could email his or her friends and family and invite them to join the cause.

To track the donations collected by the fundraiser, the fundraising platform associates each fundraiser with a unique identifier. The unique identifier may be associated with the fundraisers in a number of ways. For example, upon registration of fundraisers with the fundraising platform, the unique identifiers may be generated and associated with the fundraisers and then provided to the fundraisers by a user interface or by being distributed to the fundraisers with a collection device. Alternatively, the unique identifiers may be generated and distributed to fundraisers by a user interface, or by distribution by the organization, or by being distributed to fundraisers with a collection device. Upon receiving the unique identifier, a fundraiser can login into the fundraising platform and register with the fundraising campaign using the unique identifier causing the fundraising platform to associate the unique identifier with the fundraiser.

Upon receiving the unique identifier, fundraisers may solicit funds from donors. Fundraisers may use a collection device of the present invention to securely collect physical donations such as cash, coins, and checks. Fundraisers may also collect using electronic transfer methods such as wire transfer, person-to-person electronic transfer, Internet currencies or the like.

After completing the fundraising, each fundraiser brings the donations to a financial institution, such as a bank, or a credit union, for deposit. The donations are deposited along with the unique identifier by including the unique identifier on the deposit slip or by any other manner of including information with a deposit transaction.

The donation platform then retrieves from financial institution an accounting of the amount deposited along with the corresponding unique identifier. The unique identifier is used to identify the fundraiser that raised the deposited donations. The accounting may be retrieved by downloading images of deposit slips of the donated funds having the unique identifiers and the amounts of donations deposited. Alternatively, the accounting may be received as a file having the unique identifiers and the amounts of donations deposited. Or, in another alternative, physical deposit slips from the financial institution may be scanned into the donation platform.

Organizations, fundraisers, and donors may then access reports generated by the donations platform to monitor the status or outcomes of fundraising campaigns. The reports may be presented as a web-based dashboard. Alternatively, a report could as be presented as an email update, SMS or text messages, print publication or any other reporting mechanism. A report may include any information about the fundraising campaign stored in the fundraising platform, such as the amount of donated funds collected by each of the fundraisers, identifying information of the fundraisers, organization goals or mission, organization logos and the like.

The collection devices of the invention are securely sealed to contain the donated funds and may carry the unique identifier. A collection device includes a body, a donation slot, a tamper-evident access mechanism, and optionally a label bearing the unique identifier. The body of the collection device contains the donations and may be used to contain a pre-printed deposit slip bearing the unique identifier. The donation slot permits donations to be placed in the body but is sized to not permit the subsequent removal of the donations. The tamper-evident access mechanism allows the donations to be removed for deposit but may not be opened without providing an obvious signal that the contents in the collection device may have been jeopardized.

Each fundraiser will receive a collection device bearing his or her assigned unique identifier. The fundraisers may then proceed to collect charitable donations using the collection devices. At a participating financial institution, the seal is broken to permit access to the donated funds and the deposit slip and the funds are deposited.

In one example, a fundraising system includes: a controller adapted to: associate a unique identifier with each of a plurality of a fundraiser participants; receive an accounting from a financial institution identifying a plurality of deposits made to a single financial account at the financial institution, wherein each deposit is associated with one of the unique identifiers; and provide a user interface adapted to identify the one or more deposits contributed by each fundraiser participant using the associated unique identifier.

The fundraising system may include one or more collection devices, wherein each collection device is associated with one of the unique identifiers. The collection devices may be tamper-evident. In some examples, the tamper-evident collection devices include a cap sealed to a body by an adhesive strip. In other examples, the tamper-evident collection devices include a pull-tab seal.

The unique identifiers may physically associated with the collection devices. In some examples, the unique identifiers are actually on the collection devices, printed, written, stickered, etc. In other examples, the unique identifiers are each provided on a deposit slip associated with the collection devices.

In some instances, the unique identifiers are associated with the collection devices prior to being associated with the fundraiser participants. In others, the unique identifiers are associated with the fundraiser participants prior to being associated with the collection devices.

In another example, a non-transitory computer readable medium includes computer-executable instructions for controlling a fundraising system, the computer-executable instructions causing the system to perform the steps of: associating a unique identifier with each of a plurality of a fundraiser participants; receiving an accounting from a financial institution identifying a plurality of deposits made to a single financial account at the financial institution, wherein each deposit is associated with one of the unique identifiers; and providing a user interface adapted to identify the one or more deposits contributed by each fundraiser participant using the associated unique identifier.

The computer-executable instructions may cause the system to perform the step of: providing a campaign module that enables a user to create a campaign by entering campaign information.

The computer-executable instructions cause the system to perform the step of: providing a unique identifier module adapted to generate unique identifiers and associate each of the unique identifiers with a fundraiser participant. Each of the unique identifiers may be associated with a fundraiser participant at the direction of an organization. Alternatively, each of the unique identifiers may be associated with a fundraiser participant at the direction of the fundraiser participant.

The computer-executable instructions may further cause the system to perform the step of: providing a financial institution accounting module adapted to receive an accounting of deposited donations, each deposited donation being associated with the corresponding unique identifier.

The computer-executable instructions may also cause the system to perform the step of: providing a reporting module adapted to provide the amount of donations collected by each of the fundraiser participants as determined by the association of each unique identifier with each deposit received. The reporting module may provide a web-based dashboard, a mobile application, etc.

An objective of the invention is to provide a solution to burdensome need for the organization to collect, consolidate, and track the donations received by fundraisers.

Another objective of the invention is to assure donors that their donations end up with the chartable organization and are not being misplaced or misappropriated.

A further objective of the invention is to assure organizations that all of the donations collected by the fundraisers are being deposited and not taken out of the collection mechanism.

Yet another objective of the invention is to provide a solution to the burden on the fundraisers to handle the donated funds in a manner to avoid the misplacement or misappropriation of the donated funds by themselves or others.

An advantage of the invention is that it provides a simple and convenient means to track the donations collected by fundraisers without the organization having to collect, consolidate and process donated funds.

Another advantage of the invention is that it provides assurance to donors and organizations that donated funds are unlikely to be misplaced or misappropriated without detection.

A further advantage of the invention is that it provides a simple and convenient means for fundraisers to handle donated funds with a reduced risk of misplacement or misappropriation of the donated funds.

Still another advantage of the invention is that fundraisers can provide donors with an electronic donation receipt through email, SMS, etc.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a diagram illustrating a system for managing donations.

FIGS. 2a, 2b, and 2c illustrate a front view of an embodiment of the collection device of the present invention.

FIGS. 3a and 3b illustrate a front view of two embodiments of the collection device of the present invention.

FIG. 4 is a flow chart illustrating a method for managing donations.

### DETAILED DESCRIPTION OF THE INVENTION

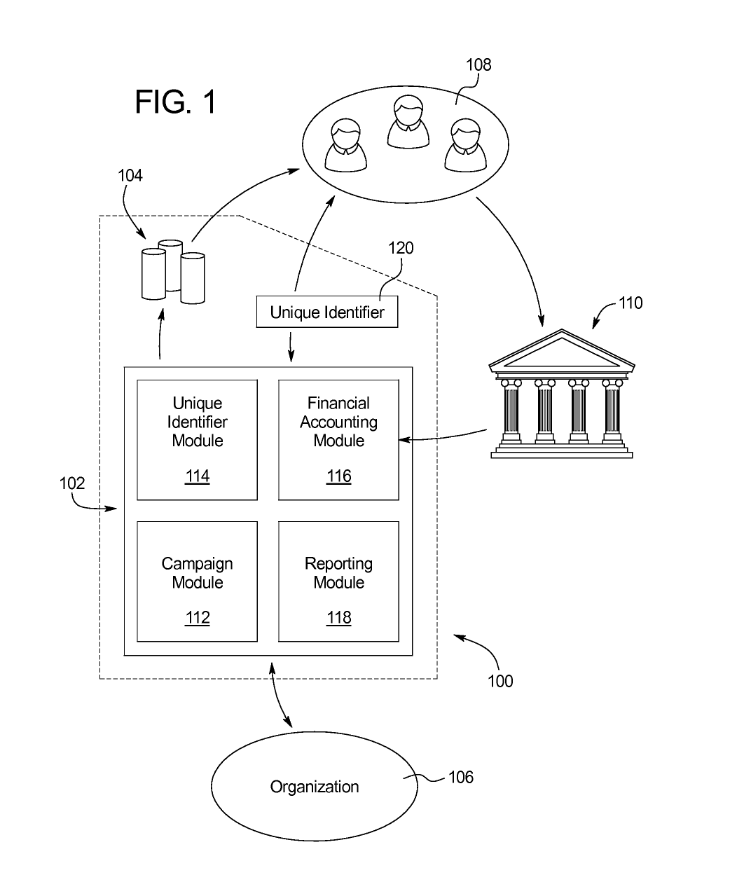

FIG. 1 shows a fundraising system 100 to enable an organization 106 to manage fundraising with a fundraising platform 102 and to track the donations raised by fundraiser participants 108 by allowing the fundraiser participants 108 to collect donations with collection devices 104 and to deposit the donations directly at a financial institution 110.

An organization 106 is an individual, group of individuals, or group of organizations having a fundraising campaign. A fundraiser participant 108 is any individual, group of individuals, or organization who intend to raise funds for an organization. Though shown as being associated with a single organization 106, a fundraiser participant 108 may be associated with numerous organizations 106 and may have a unique identifier 120 for each, as will be discussed further herein. A financial institution 110 is any institution, such as a bank, credit union, etc., able to receive funds on behalf of the organization and provide an accounting to the fundraising platform 102, and a fundraising campaign may accept donations at multiple financial institutions. The fundraising platform 102 may be accessed across a network, such as the Internet, by any network capable device such as a personal computer, mobile device, or the like.

In the example shown in FIG. 1, the fundraising platform 102 includes: a campaign module 112, a unique identifier module 114, a financial institution accounting module 116, and a reporting module 118.

In the example shown in FIG. 1, the campaign module 112 is adapted to receive fundraising campaigns from an organization 106 having fundraiser participants 108. As an example, an agent of the organization 106 will start the process of creating a new campaign by registering the organization 106 and fundraising campaign with the campaign module 112 by entering campaign information (organization information, campaign name, mission, goals, etc.). As used herein, an agent is any person that creates a new campaign, whether officially associated with the organization 106, unofficially associated with the organization 106, or not associated with the organization 106 at all. After registration, the organization 106 may enter identifying information (name, contact information, role, reporting information, etc.) of fundraiser participants 108 involved in the fundraising campaign. The identifying information of the fundraiser participants 108 may be manually entered into a web form or automatically uploaded via a file. In other embodiments, the fundraiser participants 108 may enter their own identifying information.

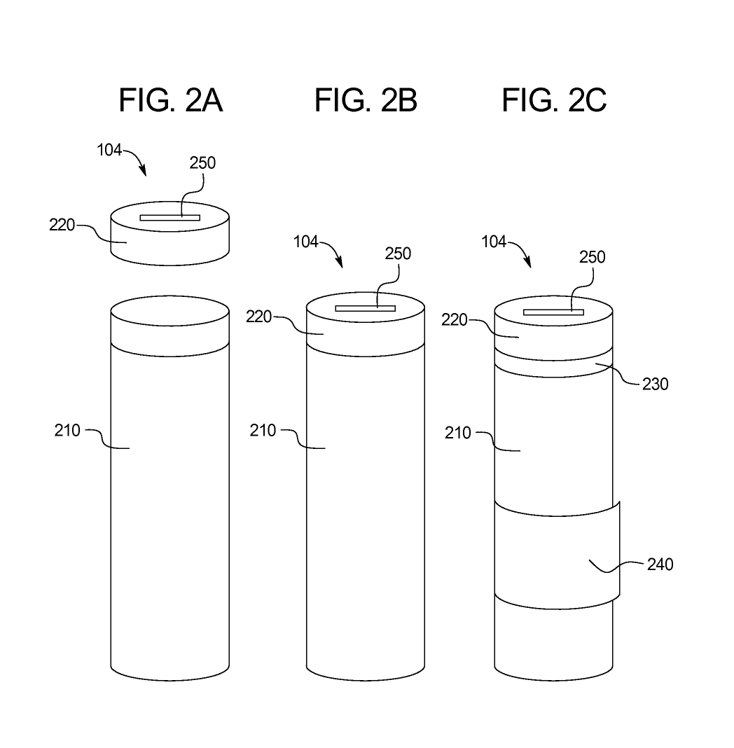

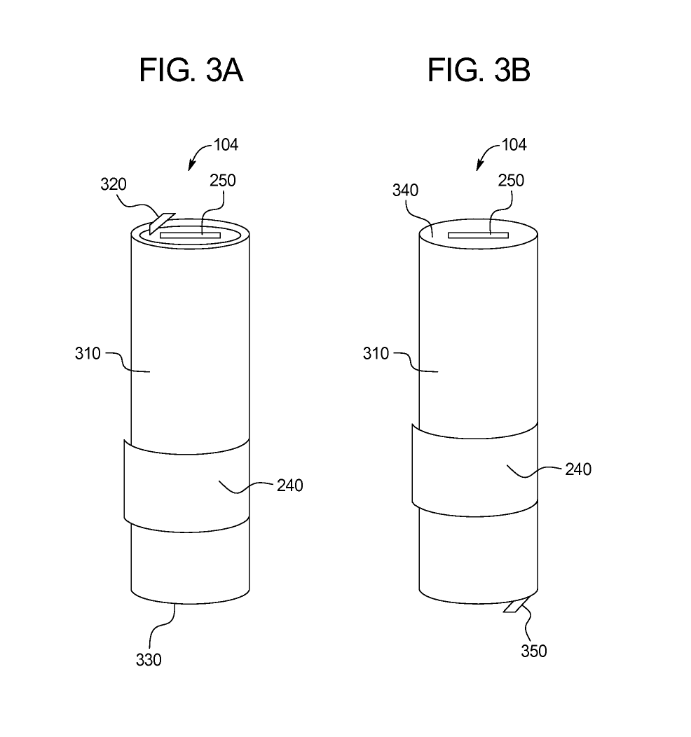

In the example shown in FIG. 1, the unique identifier module 114 is adapted to generate unique identifiers and associate each of the unique identifiers with a fundraiser participant 108. The unique identifiers can be serial numbers, membership numbers, web addresses, uniform resource indicators, or any other type of information capable of uniquely identifying the fundraiser participants 108. The unique identifiers may be associated with a fundraiser participant 108 upon registering with the fundraising campaign. In a preferred embodiment, after generation, the unique identifiers are distributed with collection devices 104 by printing the unique identifier on a label 240 (FIGS. 2c, 3a, 3b), by printing the unique identifier on a deposit slip distributed within the collection devices 104, or both. The collection devices 104 may then be distributed to fundraiser participants 108 by the organization 106, or otherwise received by the fundraiser participants 108. Upon receipt of the collection devices 104, if not already registered with the fundraising platform 102, fundraiser participants 108 may register with the fundraising campaign using the fundraising platform 102 by entering the unique identifier. Alternatively, the organization 106 may distribute the unique identifiers directly to fundraiser participants 108. In another embodiment, the fundraiser participants 108 may obtain the unique identifiers directly by logging into the fundraising platform 102 and receiving the unique identifier from the unique identifier module 114.

In the example shown in FIG. 1, upon receipt of the unique identifiers, fundraiser participants 108 solicit donations from donors. The fundraiser participants 108 may collect donations as coins, cash, checks, wire transfer, person-to-person electronic transfer, Internet currencies, or by any other means of transferring funds person-to-person. Physical donations such as coins, cash, and checks, may be collected using collection devices 104. For non-physical donations, the unique identifier may be used to accept donations, for example, by scanning a QR code containing the unique identifier with a mobile device or other QR code reader. After scanning the QR code, the donor would be directed to make an online donation. It is understood that other variations of using the unique identifier to collect electronic payments would be apparent to one of ordinary skill using the examples given.

In the example shown in FIG. 1, after collecting donations, fundraiser participants 108 will deposit their donations at a financial institution 110. While making their deposit at a financial institution 110, the fundraiser participants 108 will provide the financial institution 110 with their unique identifier. The unique identifier may be provided to the financial institution 110 on a pre-printed deposit slip, hand-written on a deposit slip by the fundraiser participants 108, or may be provided using a smartphone deposit application created by the financial institution 110 that allows the fundraiser participants 108 to communicate their unique identifier, or may be provided in any other manner associating the unique identifier with the deposit transaction.

In the example shown in FIG. 1, a financial institution accounting module 116 is adapted to receive an accounting of deposited donations with the associated unique identifier from the financial institutions 110. The financial institution accounting module 116 may retrieve the accounting by remotely connecting to servers of the financial institutions 110 and downloading images of deposit slips of the donations having the unique identifiers contained in the images, or downloading a file containing the unique identifiers along with the amount of donations deposited. Alternatively, deposit receipts may be received in a physical form and then scanned into the financial institution accounting module 116. It is understood that other variations of receiving an accounting of deposited donations from a financial institution 110 would be apparent to one of ordinary skill using the examples given.

In the example shown in FIG. 1, a reporting module 118 is adapted to generate reports on the progress and outcome of a fundraising campaign. As an example, a report may be presented as a web-based dashboard. However, a report could as be presented as an email update, mobile application, SMS, text messages, print publication or any other reporting mechanism able to convey the status or outcome of a fundraising campaign. Examples of reports that may be generated by the reporting module include: campaign progress reports; status reports; outcome reports; financial reporting for tax and compliance; reports for the membership; reports for public consumption and public relations, etc. A report may include any information about the fundraising campaign stored in the fundraising platform 102, such as the amount of donations collected by each of the fundraiser participants 108, identifying information of the fundraiser participants 108, organization goals or mission, organization logos and the like. It is understood that numerous variations of reports would be readily apparent to one of ordinary skill using the examples provided.

Referring now to FIGS. 2a through 2c, FIGS. 2a through 2c illustrate an embodiment of the collection device 104 for use in the present systems and with the present methods. Specifically, FIG. 2a illustrates an embodiment of the collection device 104 in an open configuration, FIG. 2b illustrates a collection device 104 in a closed configuration, and FIG. 2c illustrates a collection device 104 in a sealed configuration. As shown in FIGS. 2a through 2c, a collection device 104 includes: a body 210, a cap 220, and an adhesive strip 230.

As shown in FIGS. 2a through 2c, the collection device 104 has a body 210 to contain the donations. As shown in FIG. 2a, the body 210 may be tapered along the top to permit the surface of the cap 220 to fit snugly with the surface of the body 210 when the cap 220 is placed on the body 210. Before capping the body 210 with the cap 220 and sealing with the adhesive strip 230, a deposit slip bearing a unique identifier may be placed in the body 210. The collection device 104 provides a convenient and secure place for the deposit slip to reside until the fundraiser participant 108 is ready to make a deposit at a financial institution 110. A label 240 bearing a unique identifier may also be affixed to the body 210. It is understood that other variations of distributing the unique identifier with a collection device 104 would be apparent to one of ordinary skill using the examples given.

As shown in FIGS. 2b and 2c, the cap 220 caps the body 210 to secure the donations during solicitation, but is removable to allow access to the donations upon removal of the adhesive strip 220. The cap 220 has a donation slot 250 sized to permit donations to be placed in the body 210 but to not permit the subsequent removal of the donations. It is contemplated that the donation slot 250 may be substituted by any other mechanism that provides the secure collection of the donations in the body 210. The cap 220 when capping the body 210 creates a flush surface that becomes a tight seal upon placement of the adhesive strip 230.

As shown in FIG. 2c, the adhesive strip 230 connects the body 210 and the cap 220 securely sealing in the donations. The adhesive strip 230 is adapted to act as a tamper-evident access mechanism. Once secured, if the adhesive strip 230 is torn off, it will provide an obvious signal that the contents in the collection device 104 may have been jeopardized. This security feature will discourage fundraiser participants 108, among others, from accessing the contents of the collection device 104 until the appropriate time.

Referring to FIGS. 3a and 3b, FIGS. 3a and 3b illustrate further embodiments of the collection device 104 for use in the present systems and with the present methods. FIG. 3a illustrates an embodiment of the collection device 104 having a body 310, a metal pull-tab top 320 having a donation slot 250, a metal end 330, and a label 240. FIG. 3b illustrates an embodiment of the collection device 104 having a body 310, a metal top 340 having a donation slot 250, a metal pull-tab bottom 350, and a label 240. The metal pull-tab top 320 and the metal pull-tab bottom 350 are sealed to the body 310 to act as a tamper-evident access mechanism. Once removed, the broken seal will provide an obvious signal that the contents in the collection device 104 may have been jeopardized.

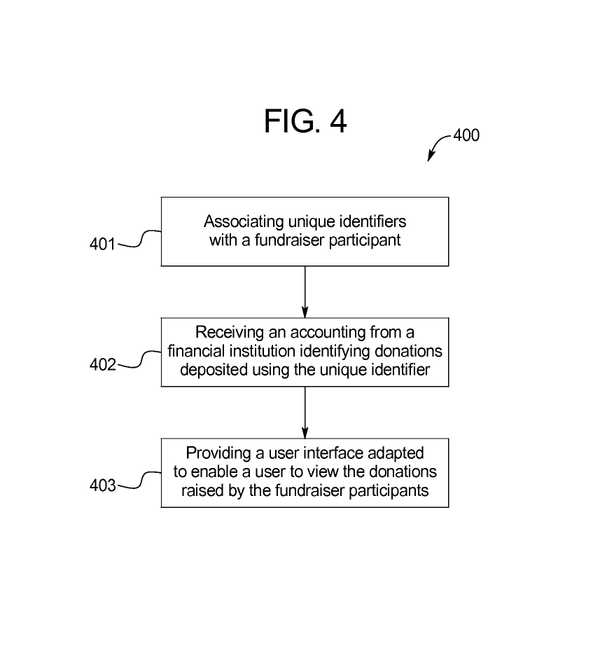

Referring to FIG. 4, FIG. 4 illustrates a method for managing fundraising (the method 400) including the steps of: a first step 401 of associating unique identifiers with fundraiser participants 108; a second step 402 of receiving an accounting from a financial institution 110 identifying donations deposited using the unique identifier; a third step 403 of providing a user interface adapted to enable a user to view the donations raised by the fundraiser participants 108.

As shown in FIG. 4, at step 401a unique identifier module 114 of a fundraising platform 102 associates unique identifiers with fundraiser participants 108. In response to the creation of a fundraising campaign, the fundraising platform 102 generates unique identifiers. In an embodiment, the unique identifiers may then be associated with the fundraiser participants 108 by the organization 106 entering the identifying information of the fundraiser participants. Alternatively, the unique identifiers may be associated with the fundraiser participants 108 when a fundraiser participant 108 is given a unique identifier or acquires a collection device 104 bearing a unique identifier and registers with the fundraising campaign using the unique identifier. It is understood that numerous variations of ways to associate unique identifiers with fundraiser participants would be readily apparent to one of ordinary skill using the examples provided.

As shown in FIG. 4, at step 402 a financial accounting module 116 of a fundraising platform 102 receives an accounting from a financial institution 110 identifying an amount of donations deposited using the unique identifier. The accounting may be accomplished by remotely connecting to servers of the financial institutions 110 and downloading images of deposit slips of the donations having the unique identifiers contained in the images, or downloading a file containing the unique identifiers along with the amount of donations deposited. Alternatively, deposit receipts may be received in a physical form and then scanned into the fundraising platform 102. It is understood that numerous variations of ways to receive an accounting from a financial institution 110 and identifying an amount of donations deposited using the unique identifier would be readily apparent to one of ordinary skill using the examples provided.

As shown in FIG. 4, at step 403 a fundraising platform 102 provides a user interface adapted to enable a user to view the donations raised by the fundraiser participants. A user of the user interface may be an organization 106, fundraiser participants 108, donors, etc. The user interface may be presented as a web-based dashboard. Alternatively, the user interface may be presented as a mobile application. The user interface may present campaign information such as the amount of donations raised by the fundraiser participants 108 as a report. Examples of reports that may be generated by the fundraising platform 102 include: campaign progress reports; status reports; outcome reports; financial reporting for tax and compliance; reports for the membership; reports for public consumption and public relations, etc. A report may include any information about the fundraising campaign stored in the fundraising platform 102, such as the amount of donations collected by each of the fundraiser participants 108, identifying information of the fundraiser participants 108, organization goals or mission, organization logos and the like. It is understood that numerous variations of providing a user interface adapted to enable a user to view the donations raised by the fundraiser participants 108 would be readily apparent to one of ordinary skill using the examples provided.

Of course it is understood that the hardware and software solutions provided herein may be incorporated into systems including a greater or lesser number of hardware components and the software components may be divided over the hardware in other configurations.

Further, while described as distinct components for purposes of clarity in the disclosure, it is recognized that the campaign module 112, the unique identifier module 114, the financial institution accounting module 116, and the reporting module 118 of the fundraising platform 102 may be integrated within a single piece of software or in multiple pieces of software in any combination. Further, it is recognized that the campaign module 112, the unique identifier module 114, the financial institution accounting module 116, and the reporting module 118 of the fundraising platform 102 may be provided on a single piece of hardware or on multiple pieces of hardware in any combination.

As will be understood by those skilled in the art based on the disclosures provided herein, aspects of the fundraising system 100, and particularly the fundraising platform 102, are controlled by a controller (which may be embodied in one or more controllers). The controller may run a variety of application programs, may access and store data, including accessing and storing data in the associated database (which may be embodied in one or more databases) and may enable one or more interactions via user interfaces, typically provided through personal computers, mobile devices, or the like. Typically, the controller is implemented using one or more programmable data processing devices. The hardware elements operating systems and programming languages of such devices are conventional in nature, and it is presumed that those skilled in the art are adequately familiar therewith. Similarly, the systems and methods described herein may be implemented on and integrated with dedicated applications, web servers, social networking platforms, etc.

For example, the controller may be a PC based or mobile electronic device based implementation of a central control processing system utilizing a central processing unit (CPU), memories and an interconnect bus. The CPU may contain a single microprocessor, or it may contain a plurality of microprocessors for configuring the CPU as a multi-processor system. The memories may include a main memory, such as a dynamic random access memory (DRAM) and cache, as well as a read only memory, such as a PROM, an EPROM, a FLASH-EPROM, or the like. The system may also include mass storage devices such as various solid-state drives, disk drives, tape drives, etc. In operation, the main memory may store at least portions of instructions for execution by the CPU and data for processing in accord with the executed instructions.

The controller may also include one or more input/output interfaces for communications with one or more processing systems. Although not shown, one or more such interfaces may enable communications via a network, e.g., to enable sending and receiving instructions electronically. The physical communication links may be wired or wireless. For example, these links may be used to communicate with the user interfaces.

The controller may further include appropriate input/output ports for interconnection with one or more displays (e.g., monitors, printers, etc.) and one or more input mechanisms (e.g., keyboard, mouse, voice input, touchscreen, etc.) to enable an operator to use the controller to provide the fundraising system 100 described herein. For example, the controller may include or be connected to a graphics subsystem to drive a display. The links to the peripherals may be wired or wireless connections.

Although summarized above as a PC-type and mobile device-type implementation, those skilled in the art will recognize that the description of the controller also encompasses all kinds of controllers such as host computers, servers, workstations, network terminals, and the like. In fact, the use of the term controller is intended to represent a broad category of components that are well known in the art.

Aspects of the fundraising system 100 encompass hardware and software for controlling the relevant functions. Software may take the form of code or executable instructions for causing a controller or other programmable equipment to perform the relevant steps, where the code or instructions are carried by or otherwise embodied in a medium readable by the controller or other machine. Instructions or code for implementing such operations may be in the form of computer instruction in any form (e.g., source code, object code, interpreted code, etc.) stored in or carried by any tangible readable medium.

It should be noted that various changes and modifications to the presently preferred embodiments described herein will be apparent to those skilled in the art. Such changes and modifications may be made without departing from the spirit and scope of the present invention and without diminishing its attendant advantages.

1. A fundraising system comprising:
a controller adapted to:
associate a unique identifier with each of a plurality of a fundraiser participants;
receive an accounting from a financial institution identifying a plurality of deposits made to a single financial account at the financial institution, wherein each deposit is associated with one of the unique identifiers; and
provide a user interface adapted to identify the one or more deposits contributed by each fundraiser participant using the associated unique identifier.

2. The fundraising system of claim 1 further including one or more collection devices, wherein each collection device is associated with one of the unique identifiers.

3. The fundraising system of claim 2 wherein the collection devices are tamper-evident.

4. The fundraising system of claim 3 wherein the tamper-evident collection devices include a cap sealed to a body by an adhesive strip.

5. The fundraising system of claim 3 wherein the tamper-evident collection devices include a pull-tab seal.

6. The fundraising system of claim 3 wherein the unique identifiers are physically associated with the collection devices.

7. The fundraising system of claim 6 wherein the unique identifiers are on the collection devices.

8. The fundraising system of claim 6 wherein the unique identifiers are each provided on a deposit slip associated with the collection devices.

9. The fundraising system of claim 1 wherein the unique identifiers are associated with the collection devices prior to being associated with the fundraiser participants.

10. The fundraising system of claim 1 wherein the unique identifiers are associated with the fundraiser participants prior to being associated with the collection devices.

11. A non-transitory computer readable medium including computer-executable instructions for controlling a fundraising system, the computer-executable instructions causing the system to perform the steps of:
associating a unique identifier with each of a plurality of a fundraiser participants;
receiving an accounting from a financial institution identifying a plurality of deposits made to a single financial account at the financial institution, wherein each deposit is associated with one of the unique identifiers; and
providing a user interface adapted to identify the one or more deposits contributed by each fundraiser participant using the associated unique identifier.

12. The computer readable medium of claim 11 further wherein the computer-executable instructions cause the system to perform the step of: providing a campaign module that enables a user to create a campaign by entering campaign information.

13. The computer readable medium of claim 11 further wherein the computer-executable instructions cause the system to perform the step of: providing a unique identifier module adapted to generate unique identifiers and associate each of the unique identifiers with a fundraiser participant.

14. The computer readable medium of claim 13 wherein the each of the unique identifiers are associated with a fundraiser participant at the direction of an organization.

15. The computer readable medium of claim 13 wherein the each of the unique identifiers are associated with a fundraiser participant at the direction of the fundraiser participant.

16. The computer readable medium of claim 11 further wherein the computer-executable instructions cause the system to perform the step of: providing a financial institution accounting module adapted to receive an accounting of deposited donations, each deposited donation being associated with the corresponding unique identifier.

17. The computer readable medium of claim 11 further wherein the computer-executable instructions cause the system to perform the step of: providing a reporting module adapted to provide the amount of donations collected by each of the fundraiser participants as determined by the association of each unique identifier with each deposit received.

18. The computer readable medium of claim 17 wherein the reporting module provides a web-based dashboard.
